(19) United States
(12) Patent Application Publication
(10) Pub. No.: US 2011/0173222 A1
(43) Pub. Date: Jul. 14, 2011

(54) DATA VALUE REPLACEMENT IN A DATABASE

(76) Inventors: Mehmet Oguz Sayal, Foster City, CA (US); Kemal Guler, San Jose, CA (US)

(21) Appl. No.: 12/686,615

(22) Filed: Jan. 13, 2010

(51) Int. Cl. G06F 17/30

(52) U.S. Cl. 707/769; 707/E17.014

(57) ABSTRACT

An exemplary embodiment of the present invention provides a method of correcting data in a database table. The method includes processing a database table to identify an incorrect data field value of a data field in the database table. The method also includes obtaining a search keyword from the database table that corresponds with the incorrect data field value. The method also includes generating a regular expression based, at least in part, on a data field type corresponding with the incorrect data field value. The method also includes searching a secondary source using the search keyword and the regular expression to identify a target data value. The method also includes replacing the incorrect value in the database table with the target data value.

### BACKGROUND

Reverse auctions are often used by business entities to procure various equipment and services from suppliers. An eSourcing system is a software tool that enables the buyer to design and manage various steps involved in a reverse auction, referred to herein as a “procurement event.” For example, the eSourcing system may enable the buyer to specify a type and quantity of items that will be bought, the suppliers that will be invited to the procurement event, the rules of the event execution, and the like. The participating suppliers may participate in the procurement event by supplying bids to the buyer through the eSourcing system. A typical bid may include a variety of information entered by the supplier, such as pricing, discount information, product descriptions, and the like. The eSourcing system may then calculate certain values from the bid information to guide the buyer's award decision. After making a final award decision, the buyer may provide details of the award allocation decision to the eSourcing system, such as which supplier was chosen, the product to be supplied, the agreed upon price, and the like.

The eSourcing system may collect the data pertaining to each procurement event in a database. Thus, the databases of such eSourcing systems could provide valuable information and insight about an organization's operations, spending, and expected future procurements. However, the typical user behavior in eSourcing systems is to enter incomplete data into the eSourcing system, and use it mainly as a communication medium to exchange information with suppliers, rather than a complete procurement management system. For example, much of the information included in a typical supplier bid may be included in an attachment rather than entered into the appropriate entry fields provided by the eSourcing system for entering bid information. This sort of user behavior makes it difficult to extract useful knowledge from eSourcing system databases, because much of the useful data is missing from the database.

### BRIEF DESCRIPTION OF THE DRAWINGS

Certain exemplary embodiments are described in the following detailed description and in reference to the drawings, in which:

FIG. 1 is a block diagram of an eSourcing system in which a buyer and seller may participate in a procurement event managed by an eSourcing application, in accordance with an exemplary embodiment of the present invention;

FIG. 2 is a process flow diagram showing a method of replacing incorrect data in the database with correct data from a secondary source, in accordance with an exemplary embodiment of the present invention;

FIG. 3 is a process flow diagram showing a method of identifying target data in a secondary source, in accordance with an exemplary embodiment of the present invention; and

FIG. 4 is a block diagram showing a tangible, machine-readable medium that stores code adapted to improve quality of data in a database, in accordance with an exemplary embodiment of the present invention.

### DETAILED DESCRIPTION OF SPECIFIC EMBODIMENTS

Exemplary embodiments of the present invention provide techniques for improving the quality of information in a database. As used herein, the term “exemplary” merely denotes an example that may be useful for clarification of the present invention. The examples are not intended to limit the scope, as other techniques may be used while remaining within the scope of the present claims. As used herein, a “database” is an integrated collection of logically related data that consolidates information previously stored in separate locations into a common pool of records that provide data for an application. For the purpose of clarity, present embodiments will be described in relation to a database generated by an eSourcing system. However, it will be appreciated that the techniques disclosed herein may also be applied to other types of databases.

Exemplary embodiments of the present invention provide a data enhancer for analyzing a database to identify data field values that may be incorrect. Upon identifying incorrect data field values in the database, the data enhancer can extract the correct information from other sources, such as attached documents included in one of the supplier bids used to populate the database. The information in the database may also provide contextual information, such as search keywords, data types, and data value ranges, which can be used to search the attachment files for the correct information. The data enhancer can automatically replace the incorrect information with the correct information identified in the attachment.

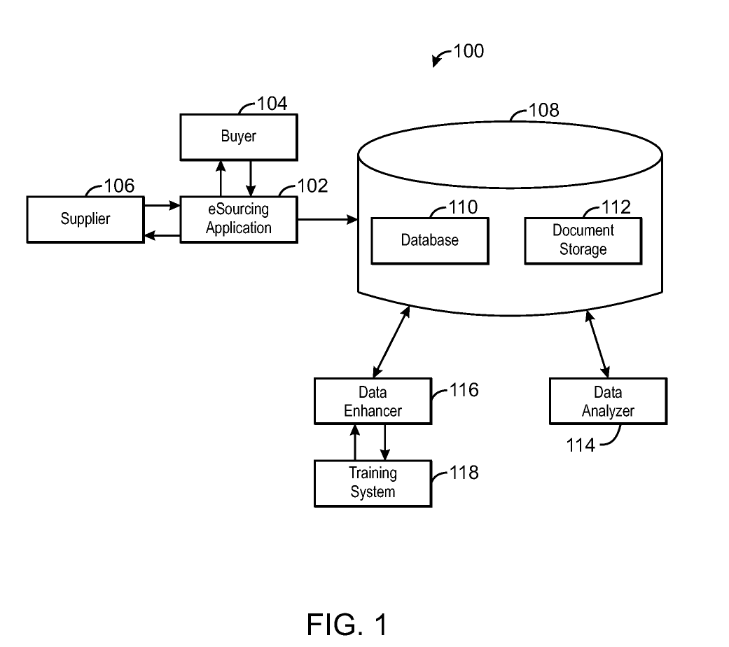

FIG. 1 is a block diagram of an eSourcing system in which a buyer and seller may participate in a procurement event managed by an eSourcing application, in accordance with exemplary embodiments of the present invention. The system 100 may include an eSourcing application 102 used to manage the various aspects of the procurement event. The eSourcing application 102 may be included on any suitable computing device, for example, an enterprise server, an application server, a general-purpose computer, and the like.

The eSourcing application 102 may be accessed by a buyer from a buyer system 104 and a supplier from a supplier system 106. The buyer system 104 and supplier system 106 may connect to the computing device on which the eSourcing application 102 resides through any suitable network connection. For example, the buyer system 104 may connect to the eSourcing application 102 through a local area network such as an Ethernet network, and the like. The supplier system 104 may connect to the eSourcing application 102 through the Internet.

The buyer system 104 may be used to define, initiate, and manage the procurement event. For example, the buyer system 104 can be used to define a procurement event by providing procurement event characteristics to the eSourcing application 102. The procurement event characteristics can specify a type of product or service to be purchased, a number of units to be purchased, an expected price range for the product, product specifications, starting and ending dates for the procurement event, and the like. The procurement event characteristics may also specify particular suppliers to be invited to the procurement event. The buyer system 104 can also be used to initiate the procurement event, upon which the eSourcing application 102 may send invitations to the identified suppliers, for example, through automatically generated email messages. The eSourcing application 102 may also provide each supplier system 106 with the procurement event characteristics, which the supplier can use to determine a bid. In some embodiment, the eSourcing application 102 generates a data entry form that may be accessed by the supplier system 106 to enable the supplier to enter details of the supplier's bid. Depending on the characteristics of the procurement event, some data entry fields of the data entry form may include pre-determined or default information. For example, the data entry from may include data entered by the buyer such as the supplier's business name, a default product quantity, and the like. Furthermore, some data entry fields may be optional while other data entry fields may be enforced. An optional data entry field is any data field that the supplier can leave blank when submitting the bid. An enforced data entry field is any data entry field that the supplier is required to fill out before the eSourcing application 102 will accept the bid. The data entry fields can be specified as optional or enforced by the procurement event characteristics provided by the designer of the procurement event.

The details of the bid can be provided by the supplier system 106 to the eSourcing application 102 through the data entry form. The bid may include a proposed price to be charged by the supplier for the products specified by the procurement event characteristics. The bid may also include additional proposed details of the procurement transaction, such as delivery date, product specifications, price discounts, contract terms, and the like. In some cases, the supplier can override the default information included in the data entry form by the eSourcing application 102. Additionally, the supplier can provide bid details through one or more additional documents attached to the bid and supplied to the eSourcing application 102 from the supplier system 106. The data entry form may include a document attachment interface that allows the supplier to attach the additional documents. The additional documents may include any suitable document, for example, MICROSOFT® WORD files, MICROSOFT® EXCEL files, ADOBE® PORTABLE DOCUMENT FILES (PDFs), eXtensible Markup Language (XML) files, Hyper-text Markup Language (HTML) files, plain-text documents, electronic mail files, and the like.

At the close of the procurement event, the buyer can review the bids provided by the suppliers 106 and decide which supplier or suppliers to award contracts. In some embodiments, the eSourcing application 102 may calculate a variety of metrics related to each bid, for example, a price per unit, total price including shipping costs, and the like. The metrics generated by the eSourcing application 102 can be used by the buyer to help the buyer make a more informed award decision.

The data related to the procurement event may be stored in a machine-readable memory 108, for example a network storage system, hard disk, and the like. The details of the procurement event, such as bid details, procurement event characteristics, final award decision, and the like, can be entered into a database table 110. The database table 110 may include a plurality of data fields that contain the data related to the procurement events, such as procurement event characteristics, bid details, and the like. Each data field may include a plurality of data field values each identifying a particular detail of a particular procurement event.

The documents related to the procurement event, such as documents attached to a supplier's bid, may be stored in a document storage system 112 of the machine-readable memory 108. A file name and location of each document may be stored in the database table 110 and can be used to obtain the documents related to a specific procurement event. A database schema associated with the database table 110 may be used to define a data type of each of the data fields, and relationships between data fields included in the database.

In some embodiments, the system 100 may include a data analyzer 114 configured to analyze the database table 110 and generate useful information regarding the procurement activities conducted through the system 100. The data analyzer 114 may be included on the same computing device as the eSourcing application 102 or any other computing device that has access to the database table 110. The data analyzer 114 may use data mining techniques to extract the useful information and generate metrics regarding the procurement activities. For example, the data analyzer 114 may compute cost trends for various products purchased by through the eSourcing application 102. In some embodiments, cost trends may be computed for individual suppliers across the range of products provided by the supplier. Any number of additional useful metrics may be computed by the data analyzer 114.

The ability of the data analyzer 114 to compute accurate procurement metrics may depend of the quality of the information included in the database 114. For various reasons, the database table 110 may sometimes include incorrect information. For example, as discussed above, many suppliers 106 can chose to supply bid details through attached documents rather than entering the corresponding data in the data entry form provided by the eSourcing application 102. In such cases, some data entry fields in the data entry form may be blank or may include default information that is incorrect as it relates to the supplied bid. For example, a particular data entry field used to represent a unit quantity may have a value of “1,” which represents a default number entered by the eSourcing application 102 to avoid division by zero, for example. Such incorrect data may not be relied on the buyer, because the buyer may be aware that the true bid details are actually included in an attachment document. Therefore, the incorrect information included in the data entry form may not cause problems during the procurement event. However, the procurement data entered into the database table 110 may include this incorrect information.

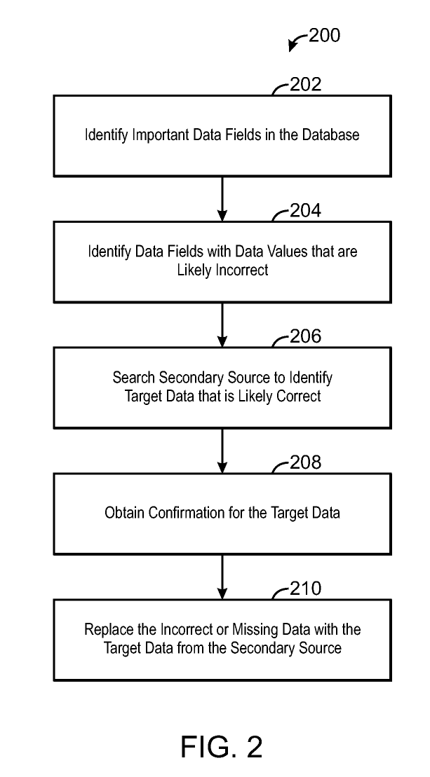

The system 100 may also include a data enhancer 116 used to improve the quality of the data in the database table 110. The data enhancer 116 may be included on the same computing device as the eSourcing application 102 or any other computing device that has access to the database table 110. As discussed further in relation to FIG. 2, the data enhancer 116 may identify potentially incorrect data and extract correct data from a secondary source such as a document related to the specific procurement event. As used herein, the correct data identified in the related document is referred to as the “target data.” In some embodiments, the data enhancer 116 may search the document for the target data using search keywords identified in the database table 110 by the data enhancer 116. For example, in one hypothetical example, the database table 110 may include a data field value that identifies a product name and a corresponding data field value that identifies a quantity of the product to be supplied. If the data enhancer 116 determines that the quantity is likely to be incorrect, then the data enhancer 116 may use the corresponding product name as a search keyword to search the document. Upon identifying the target data, the incorrect information in the database table 110 may then be replaced by the target data extracted from the document.

In some exemplary embodiments, system 100 may include a training system 118 communicatively coupled to the data enhancer 116 and used to verify the accuracy of the target data. The training system 118 may include software and hardware programmed to verify the accuracy of the target data identified by the data enhancer 116. In some embodiments, the data enhancer 116 sends a confirmation request to the training system 118 that requests confirmation of the proposed data replacement, as described further in relation to FIG. 2. The training system 118 may then accept or reject the proposed data replacement identified by the data enhancer 116.

In some embodiments, the replacement decision may be made by a person. In such embodiments, the training system 118 may include a display for displaying the proposed replacement to a human user and input controls for accepting the user decision. The user can then accept or reject the proposed replacement based on the user's knowledge of the procurement process.

In some embodiments, the data enhancer 116 may also include a machine-learning program that is used to increase the accuracy of the data extraction performed by the data enhancer 116. In such embodiments, the data enhancer 116 may learn from the user feedback by keeping track of which data values are accepted by the user through the training system 118. The data enhancer 116 may collect information about the structure of data sources, relative location, distance of the target data with respect to search keywords, the range of data values accepted by the user for individual data fields, and the like. The collected information may be used for increasing the accuracy of the automatic data extraction and replacement into the database table 110. Eventually, the machine-learning program may reach an accuracy level that enables the data enhancer 116 to conduct data replacements with little or no input by a human user.

FIG. 2 is a process flow diagram showing a method of replacing incorrect data in the database with correct data from a secondary source, in accordance with exemplary embodiments of the present invention. Referring also to FIG. 1, the method 200 will generally be executed by the data enhancer 116 using data from the database table 110 and documents stored in the document storage system 112. However, in other exemplary embodiments, all or part of the method 200 may be executed on other devices, such as the eSourcing application 102 or the data analyzer 114.

The method 200 may begin at block 202, wherein important data fields in the database table 110 are identified. In some embodiments, the database table 110 may include data fields that contain operational data for the eSourcing application 102, such as system logs regarding user logins and logouts, user types or roles, system maintenance, and the like. The database table 110 may also include data fields related to the details of procurement events, for example, the items being purchased, suppliers and their bids, event rules, award decisions, and the like. Such procurement event related data fields may be used to generate procurement metrics and may be flagged or otherwise identified as important data fields.

In some embodiments, the data enhancer 116 may be programmed to identify important data fields based on domain knowledge of the database table 110. In other embodiments, the identification of important data fields may include flagging all data fields in the database table 110 except for those data fields that relate to operational data for the eSourcing application 102. For example, the data enhancer 116 may identify data fields related to operational data by identifying certain keywords contained in a data field header that may indicate that the corresponding data field pertains to operational data, for example, keywords such as “log in,” “log out,” “user”, and the like. All other data fields may then be identified as important data fields. In some embodiments, the important data fields may be identified based on the type of analysis to be performed by the data analyzer 114. For example, data fields pertaining to a particular product or supplier may be identified as important based on keywords such as a product name or supplier name, for example.

At block 204, the data enhancer 116 may identify incorrect data field values in the important data fields. As used herein, an incorrect data field value is a data field value that is certain to be incorrect or is likely to be incorrect. Those data field values that are identified as incorrect may be flagged or otherwise identified by the data enhancer 116 for further processing, as described further below in reference to block 206. In some embodiments, identifying the incorrect data field values may include identifying empty, or null, data field values. In some embodiments, identifying the incorrect data field values may include identifying zeros in numerical data fields or empty character strings in textual data fields.

In some exemplary embodiments, identifying the incorrect data field values may include identifying outliers, in other words, data field values that fall outside of an expected range, which may be determined from the other data field values in the same data field. For example, if a large percentage of values in a particular data field fall within a relatively narrow range, those values that fall outside the expected range may be considered outlying data field values, and may be identified as incorrect. In one hypothetical example, 95% of the data field values for a price data field may fall within a range of 800 to 1000 dollars. Thus, the range of 800 to 1000 may be identified by the data enhancer 116 as an expected range for the data field, and all data field values outside of this range may be identified by the data enhancer 116 as incorrect. In some embodiments, a standard deviation may be computed for the data field values to determine the expected range of data field values.

In some exemplary embodiments, the data field values of a particular data field may be divided into comparison groups that are used to determine outliers. Comparison groups may be determined based on corresponding data in other data fields. For example, a comparison group may be generated for data field values that correspond with a particular product type. In such embodiments, the expected range may be computed for the comparison group and used to identify incorrect data within the same comparison group. In this way, the expected range of data field values used to identify outliers may be narrowed to data field values that should be similar.

In some exemplary embodiments, identifying incorrect data may include identifying default values. As noted above, the eSourcing application 102 may, in some cases, insert default values into the data entry from used by the suppliers 106. This may be done to avoid computational errors that could occur when the eSourcing application 102 computes various bid characteristics or the data analyzer 114 computes various procurement metrics. For example, a quantity of products to be supplied may be set to a default value of one to avoid division by zero when calculating a cost per unit. Thus, some data fields may include frequently repeated default values entered by the eSourcing application 102. Such repeating values may be identified as incorrect. In some embodiments, default values may be identified by computing a data distribution for the data field and identifying the most frequently repeated value, or mode, based on the data distribution. The number of occurrences of the most repeated value may be compared to the cardinality of the data field, in other words, the number of data elements in the data field. If the ratio of the occurrence count of the mode to the cardinality of the table is high, the mode value may be flagged as an automatically entered default value. Each occurrence of the default value in the data field may be identified as incorrect. After identifying incorrect data field values, the process flow may advance to block 206.

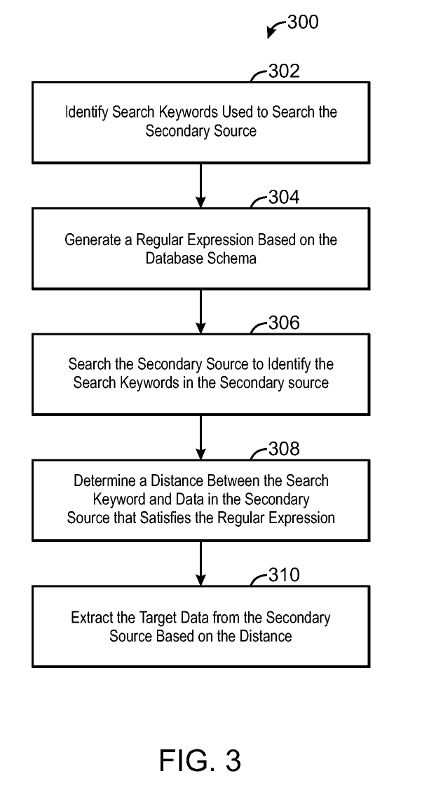

At block 206, one or more secondary sources may be searched to identify the target data that may be used to replace the incorrect data that was identified at block 204. As noted above, the secondary source may be a document attached to a supplier bid and stored to the document storage system 112. A filename and location of the document may be included in the database table 110 and associated with a particular procurement event and supplier. Techniques for searching the secondary sources for target data are described further in relation to FIG. 3. After identifying the target data, the process flow may advance to block 208.

At block 208, the data enhancer 116 may obtain confirmation of the target data. In some embodiments, obtaining confirmation of the target data may include generating a proposed data replacement and sending a confirmation request to the training system 118. The confirmation request may include any information about the proposed data replacement suitable for enabling the user of the training system 118 to determine the accuracy of the proposed data replacement. For example, the confirmation request may include the identified incorrect data, and the target data extracted from the attached document, a name of the data field in which the data resides, and the like. The confirmation request may also include other data field values corresponding to the same procurement event as the incorrect data. For example, if the incorrect data is in a data field relating to a product price, the confirmation request may include a data field value that identifies the corresponding product. In some embodiments, the confirmation request may also include other data field values in the same data field as the incorrect data.

Upon receiving the confirmation request, the user of the training system 118 can confirm or reject the proposed data replacement indicated by the confirmation request. Upon receiving confirmation of the proposed data replacement, the process flow may advance to block 210, wherein the identified incorrect data may be replaced by the target data identified in the secondary source.

As noted above in relation to FIG. 1, the data enhancer 116 may include a machine-learning program used to increase the accuracy of the target data identification performed by at block 206. In such embodiments, the machine-learning program may generate search rules based on the proposed data replacements that are confirmed through the training system 118. The generation of search rules may be better understood with reference to FIG. 3, which describes techniques for identifying the target data within secondary sources. In some embodiments, the accuracy of the target data identification performed by at block 206 may high enough that confirmation of the proposed data replacement is no longer used, in which case block 208 may be skipped.

FIG. 3 is a process flow diagram showing a method of identifying target data in a secondary source, in accordance with exemplary embodiments of the present invention. The method 300 may be implemented at block 206 (FIG. 2) and may begin at block 302, wherein search keywords are determined. In some embodiments, the search keywords may be determined using a domain specific dictionary, or ontology. For example, if the incorrect data is in a data field that relates to a product quantity or volume, the keywords such as “quantity,” “volume,” “amount,” “units,” “tons,” “boxes,” “packages,” and the like, may be used as search keywords for searching the secondary source. The domain specific ontology can be manually generated based on knowledge of the specific domain in which the data resides. For example, domain specific ontology can be based on knowledge about the specific procurement event corresponding with the data.

In some embodiments, one or more search keywords may be generated automatically based on other data in the database table 110 that is related to the data field with the incorrect data field value. For example, if the incorrect data field value relates to a quantity of a specific product, corresponding data, such as a product name, part number, and supplier name may be obtained from the database table 110 and used as a search keyword. In some embodiments, the automatically generated keywords may be obtained from enforced data fields, which are more likely to contain correct information.

At block 304, a regular expression may be automatically generated by the data enhancer 116 based, in part, on the database schema and other data field values in the database table 110 that correspond with the incorrect data value. As used herein, a “regular expression” refers to a data format specification that describes certain textual or numerical characteristics of a string and a degree of variability of the string. In one exemplary embodiment, the regular expression may be determined based, in part, on the data type specified by the database schema for the data field corresponding with the incorrect data field value. For example, if the database schema identifies the corresponding data field as a dollar value, the regular expression may specify a dollar value format. If, however, the database schema identifies the corresponding data field as a text string with 12 characters, the regular expression may specify a textual data type and a text string of ten characters.

In another exemplary embodiment, the regular expression may be generated based on correct data field values in the same data field as the incorrect value. The correct data field values may be used to determine a range of acceptable values that the correct data may be expected to fall within. For example, if the data field pertains to a product price, and most or all of the correct data values in the data field fall within a certain price range, the regular expression may specify a dollar value within that price range.

At block 306, the keywords and regular expressions may be used to search the secondary source for the target data. In some embodiments, the secondary source may include one or more documents stored in the document storage system 112. The name and location of the documents may be identified by an attachments data field included in the database table 110. The data enhancer 116 may search the documents to determine whether the document includes one or more of the search keywords identified at block 302. If a document includes at least one of the search keywords, the process flow may advance to block 308.

At block 308, the data enhancer 116 may search the document for data that satisfies the automatically generated regular expression. In most cases, it is likely that the desired data value that represents the correct procurement event data will generally be close to the search keyword. Thus, if more than one data value satisfies the regular expression, the data enhancer may determine a distance between the search keyword and each of the data values that satisfy the regular expression. Each data values that satisfy the regular expression may be referred to as a “prospective” data value. The distance may be used to determine which prospective data value is more likely to be the correct data. In some exemplary embodiments, the distance may be a word distance computed by determining a number of words between the search keyword and the prospective data value. In other words, the word distance may be the number of words in the document that separate the search keyword from the prospective data value.

In some exemplary embodiments, the distance measured between the search keyword and the prospective data value may be a structural distance. A document structure refers to the relative positional relationship between data fields of the document as defined by document layout parameters. The structural distance refers to the relative positional distance between the search keyword and the prospective data as determined by the document structure. The structural distance may be determined by first identifying the structural information included in the document. For example, the data fields of the document, including the search keyword and the prospective data values may be included in a table, for example, a MICROSOFT® EXCEL spreadsheet, a MICROSOFT® WORD table, and the like. In such embodiments, the structural information may include row and column numbers for each document data field. The structural distance may be computed as a number of rows or columns between the search keyword and the prospective data.

In some embodiments, the structural information may be identified by converting the document into an XML document. The resulting XML document may include XML markup code, for example, tags, labels, elements, and attributes that describe the structure of the document. The markup code may include a hierarchical tree structure of data fields that describe the structural layout of the document. In some embodiments, the XML document may include row and column data that describes the relative location of the search keywords and the prospective data within one or more tables. The structural distance may then be computed as the number of rows and columns between the search keywords and the prospective data. Furthermore, in some embodiments, the tree structure of the markup code (e.g., XML) may also be used to determine the structural distance. For example, the search for data values that satisfy the regular expression may be limited to data values at the same level of hierarchy or same table as the search keywords. In another embodiment, the structural distance may be computed as the number of hierarchical levels between the search keywords and the prospective data.

In some exemplary embodiments, the distance measured between the search keyword and the prospective data value may be a geometric distance. For example, some documents, such as PDF documents, Joint Photographic Experts Group (JPEG) files, bitmap files, and the like, may be encoded with coordinate data that describes a geometric location of each textual element in the document. The coordinate data may be expressed in units of pixels, inches, centimeters, or any other suitable unit of measure. In such embodiments, the distance between the search keyword and the prospective data may be computed by any suitable mathematical operation, for example subtracting the coordinates of the prospective data from the coordinates of the search keyword.

The particular distance calculation performed may depend on the type of document. Furthermore, one or more distance measurement techniques described above may be used in combination. After computing distances between each of the prospective data values and the corresponding search keyword, the process flow may advance to block 310.

At block 310, the data enhancer 116 may extract the target data from the document based, in part, on the distance. In some embodiments, the prospective data value with the least distance from the search keyword may be selected as the target data. In some embodiments, the target data may be selected as the prospective data value with the least distance from the search keyword in a particular direction.

As noted above, at block 208 of FIG. 2, the data enhancer 116 may, in some embodiments, submit a confirmation request to the training system 118 to verify the accuracy of the proposed data replacement. In such embodiments, the user of the training system 118 can reject the proposed data replacement. In such instances, the data enhancer 116 may then select another prospective data value as the target data. For example, the data enhancer 116 may select the prospective data with the next least distance from the search keyword, or the prospective data in a different direction from the search keyword. The new target data may then be submitted to the training system 116 for verification. This process may be repeated until the user accepts the proposed data replacement or no further prospective data values are available.

As noted above, in relation to FIG. 2, if a proposed data replacement is accepted, the data enhancer 116 may generate one or more search rules used to improve the accuracy of the target data identification. In some embodiments, the search rule may include characteristics used to determine when to apply the search rule. For example, documents having the same document type or document name or generated by the same document author may be more likely to be structured similarly. Thus, the characteristics used to determine when to apply the search rule may include, for example, a document type, a document name, a document author, and the like. In some embodiments, the document author may be determined from meta-data associated with the document. In some embodiments, the document author may be the name of the supplier that provided the document, as indicated in the database table 110.

In some exemplary embodiments, the search rule may include the particular search keyword that was identified in the document. In such embodiments, the document may be searched using the particular search keyword included in the search rule rather than the group of search keywords identified at block 302. The search rule may also include one or more search characteristics that identify the location in which the approved target data was found in relation to the search keyword, for example, the maximum distance between the search keyword and the target data, the direction of the target data in relation to the search keyword, and the like.

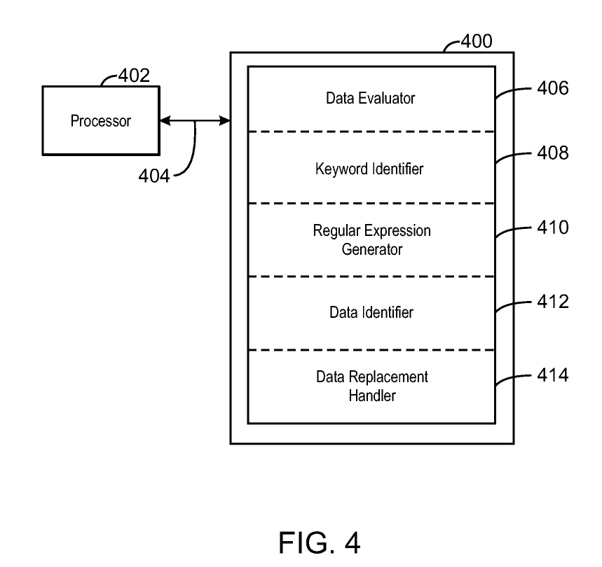

FIG. 4 is a block diagram showing a tangible, machine-readable medium that stores code adapted to improve quality of data in a database, in accordance with an exemplary embodiment of the present invention. The tangible, machine-readable medium is generally referred to by the reference number 400. The tangible, machine-readable medium 400 can comprise Random Access Memory (RAM), a hard disk drive, an array of hard disk drives, an optical drive, an array of optical drives, a non-volatile memory, a Universal Serial Bus (USB) flash drive, a DVD, a CD, a holographic storage system, and the like. In one exemplary embodiment of the present invention, the tangible, machine-readable medium 400 can be accessed by a processor 402 over a computer bus 404.

The various software components discussed herein can be stored on the tangible, machine-readable medium 400 as indicated in FIG. 4. For example, a first block 406 on the tangible, machine-readable medium 400 may store a data evaluator configured to identify an incorrect data field value of a data field the database. A second block 408 can include a keyword identifier configured to obtain a search keyword from the database that corresponds with the incorrect data field value. A third block 410 can include a regular expression generator configured to generate a regular expression based, at least in part, on a database schema of the database. A fourth block 412 can include a data identifier configured to search the document using the search keyword and the regular expression to identify a target data value. A fifth block 414 can include a data replacement handler configured to replace the incorrect value in the database with the target data value.

Although shown as contiguous blocks, the software components can be stored in any order or configuration. For example, if the tangible, machine-readable medium 400 is a hard drive, the software components can be stored in non-contiguous, or even overlapping, sectors.

What is claimed is:

1. A method comprising:
processing a database table to identify an incorrect data field value of a data field in the database table;
obtaining a search keyword from the database table that corresponds with the incorrect data field value;
generating a regular expression based, at least in part, on a data field type corresponding with the incorrect data field value;
searching a secondary source using the search keyword and the regular expression to identify a target data value; and
replacing the incorrect value in the database table with the target data value.

2. The method of claim 1, wherein searching the secondary source further comprises:
identifying the search keyword in the secondary source;
indentifying a prospective data value in the secondary source that satisfies the regular expression; and
determining a distance between the search keyword and the prospective data value.

3. The method of claim 2, wherein determining the distance comprises computing determining a geometric distance between the search keyword and the prospective data value based, at least in part, on a geometric location information included in the secondary source.

4. The method of claim 2, wherein determining the distance comprises converting the secondary source into an eXtensible Markup Language (XML) format and determining a number of rows and columns between the search keyword and the prospective data value.

5. The method of claim 2, comprising generating a search rule that includes the distance and at least one of the search keyword, a document name, a document type, and a document author.

6. The method of claim 1, wherein generating the regular expression comprises determining a range of acceptable values based, at least in part, on other data field values in a same data field as the incorrect data field value.

7. The method of claim 1, further comprising:
generating a proposed data replacement that includes the target data value;
submitting the proposed data replacement to a training system; and
receiving a confirmation message from the training system.

8. The method of claim 1, wherein identifying the incorrect data field value comprises detecting an outlying data field value that falls outside of a range determined by other data field values in the same data field.

9. The method of claim 1, wherein identifying the incorrect data field value comprises detecting a default value by identifying a most frequently repeated value of the data field, and computing a ratio of a number of occurrences of the most frequently repeated value to a cardinality of the data field.

10. A system comprising:
a processor that is adapted to execute machine-readable instructions;
a storage device that is adapted to store a database table and a document corresponding to information in the database table; and
a memory device that stores instructions that are executable by the processor, the instructions comprising:
a data evaluator configured to identify an incorrect data field value of a data field in the database table;
a keyword identifier configured to obtain a search keyword from the database table that corresponds with the incorrect data field value;
a regular expression generator configured to generate a regular expression based, at least in part, on a data field type corresponding with the incorrect data field value;
a data identifier configured to search the document using the search keyword and the regular expression to identify a target data value; and
a data replacement handler configured to replace the incorrect value in the database table with the target data value.

11. The system of claim 10, comprising a computing device configured to manage a procurement event and store procurement event characteristics and bid details to the database table.

12. The system of claim 10, wherein the data replacement handler is configured to:
send a confirmation request to a training system, the confirmation request comprising a proposed data replacement; and
receive a confirmation of the proposed data replacement from the training system.

13. The system of claim 10, wherein the data identifier is configured to:
identify the search keyword in the document;
indentify a prospective data value in the document that satisfies the regular expression; and
determine a distance between the search keyword and the prospective data value, wherein the prospective data with the least distance from the search keyword is identified as the target data.

14. The system of claim 13, wherein the document includes a table and determining the distance comprises converting the document into an XML format and determining a number of rows and columns between the search keyword and the prospective data value.

15. The system of claim 10, wherein the data evaluator is configured to
detect an outlying data field value that falls outside of a range determined by other data field values in the same data field.

16. The system of claim 10, wherein the data evaluator is configured to detect a default value by identifying a most frequently repeated value of the data field, and computing a ratio of a number of occurrences of the most frequently repeated value to a cardinality of the data field.

17. A tangible, computer-readable medium, comprising code configured to direct a processor to:
identify an incorrect data field value of a data field in a database table;
obtain a search keyword from the database table that corresponds with the incorrect data field value;
generate a regular expression based, at least in part, on a data field type corresponding to the incorrect data field value;
search the document using the search keyword and the regular expression to identify a target data value; and
replace the incorrect value in the database table with the target data value.

18. The tangible, computer-readable medium of claim 17, comprising code configured to direct a processor to:
identify the search keyword in the document;
indentify a prospective data value in the document that satisfies the regular expression; and
determine a distance between the search keyword and the prospective data value, wherein the prospective data with the least distance from the search keyword is identified as the target data.

19. The tangible, computer-readable medium of claim 18, comprising code configured to convert the document to an XML format.

20. The tangible, computer-readable medium of claim 18, comprising code configured to detect a default value of the data field by identifying a most frequently repeated value of the data field, and computing a ratio of a number of occurrences of the most frequently repeated value to a cardinality of the data field.
